(19) United States
(12) Patent Application Publication
(10) Pub. No.: US 2024/0185079 A1
(43) Pub. Date: Jun. 6, 2024

(54) SEMI-SUPERVISED SIMILARITY-BASED CLUSTERING IN RESOURCE EVALUATION

(71) Applicant: International Business Machines Corporation, Armonk, NY (US)

(72) Inventors: Yash Vardhan Singh, Bangalore (IN); Khushboo Tak, Bangalore (IN); Parmar Yogeshbhai, Gujarat (IN); Trapti Kalra, Gurgaon (IN)

(21) Appl. No.: 18/061,529

(22) Filed: Dec. 5, 2022

(51) Int. Cl. G06N 3/0895; G06N 3/04

(52) U.S. Cl. CPC G06N 3/0895; G06N 3/04

(57) ABSTRACT

A holistic approach to determining resource authenticity using similarity-based clustering of resource images. Resource images are input to generate image embeddings for an embedding space including generated embeddings for known authentic and known counterfeit resources. Similarity-based clustering processes identify outlier embeddings in the embedding space for determination of authenticity. A set of outlier embeddings for counterfeit resource images is the basis for creating new clusters representing previously unrecognized counterfeit resources.

### BACKGROUND

The present invention relates generally to the field of resource control, and more particularly to evaluating resources for unauthorized origination.

A siamese neural network is a class of neural network architectures that contains two or more identical sub-networks. The siamese network uses the same weights and same convolution neural network (CNN) structure. An embedding is a mapping of a discrete, categorical variable to a vector of continuous numbers. Embeddings are low-dimensional, learned continuous vector representations of discrete variables. An image embedding is a lower-dimensional representation of a given image. In other words, it is a dense vector representation of the image that can be used for many tasks such as classification within a vector space. Image embedding may be used in classifying images input to the CNN structure.

The K-medoid clustering problem is similar to the K-means clustering problem. K-medoid is a portioning algorithm that attempts to minimize the distance between points labeled to be in a cluster and a point designated as the center of that cluster. K-medoid clustering chooses actual data points as centers, medoids or exemplars, and thereby facilitates interpretability of the cluster centers.

### SUMMARY

In one aspect of the present invention, a computer program product for detecting a counterfeit product includes: loading a first embedding of a first image into an embedding space where there is a plurality of existing clusters of other image embeddings, the plurality of existing clusters having defined respective medoids and corresponding cluster thresholds, the plurality of existing clusters including an authentic class cluster and a counterfeit class cluster; and determining medoid distances between the first embedding and the respective medoids of the plurality of existing clusters; comparing a first medoid distance to a corresponding cluster threshold of a first cluster; responsive to no medoid distance to any cluster being less than respectively corresponding cluster thresholds, assigning the first embedding to a set of outlier embeddings not matching any cluster; and reporting the first image as representing a counterfeit resource.

In another aspect of the present invention, a computer program product for detecting a counterfeit product includes: training a siamese network of shared parameters with pairs of images representing authentic and counterfeit resources to create the trained siamese network, the siamese network generating image embeddings of each image; generating, by the siamese network and under expert supervision, K-medoids models for creating a cluster of authentic image embeddings and a cluster of counterfeit image embeddings; calculating integrity of cluster (IOC) for clusters created by the K-medoids models, the IOC being based on a count of ground truth labels in each cluster, a total number of image embeddings in each cluster, and a total number of clusters in the embedding space; and selecting the selected K-medoids model from a set of K-medoids models based on a comparison of the calculated IOC of clusters created by each K-medoids model, the selected K-medoids model having a preferred IOC. The at least two existing clusters were created by a selected K-medoids model.

In yet another aspect of the present invention, a computer program product for detecting a counterfeit product includes: determining a count of outlier embeddings in the set of outlier embeddings; responsive to the count meeting at least a threshold number of embeddings, generating a new cluster in the embedding space; generating a global threshold for plurality of existing clusters in the embedding space; selecting a best center among the set of outlier embeddings in the embedding space, wherein selected close outlier embeddings make up a set of non-outlier embeddings having the best center as a new medoid of the new cluster; and generating a cluster threshold for the new cluster based on a minimum distance from the new medoid to enclose the set of non-outlier embeddings.

### BRIEF DESCRIPTION OF THE SEVERAL VIEWS OF THE DRAWINGS

FIG. 1 is a schematic view of a first embodiment of a system according to the present invention;

FIG. 2 is a flowchart showing a first method performed, at least in part, by the first embodiment system;

FIG. 3 is a schematic view of a machine logic (for example, software) portion of the first embodiment system;

FIG. 4 is a flowchart showing a second method performed, at least in part, by the first embodiment system;

FIG. 5 is a flowchart showing a third method performed, at least in part, by the first embodiment system;

FIG. 6 is a flowchart showing a fourth method performed, at least in part, by the first embodiment system; and

FIG. 7 is a flowchart showing a fifth method performed, at least in part, by the first embodiment system.

### DETAILED DESCRIPTION

A holistic approach to determining resource authenticity using similarity-based clustering of resource images. Resource images are input to generate image embeddings for an embedding space including generated embeddings for known authentic and known counterfeit resources. Similarity-based clustering processes identify outlier embeddings for determination of authenticity. A set of outlier embeddings for counterfeit resource images is the basis for creating new clusters representing previously unrecognized counterfeit resources. The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as resource evaluation program 300 and training program 500. In addition to blocks 300 and 500, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and blocks 300 and 500, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

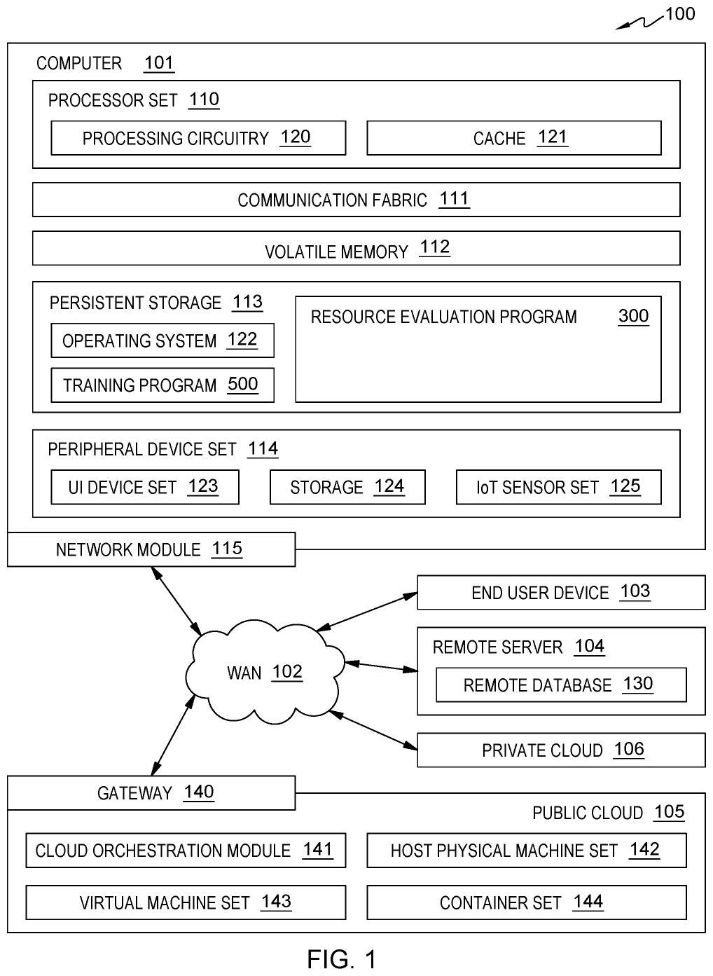

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 300 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 300 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Resource evaluation program 300 operates to train an evaluation model identify unauthorized originators of specified resources and establish new clusters as new example resources are identified within evaluation samples.

Some embodiments of the present invention recognize the following facts, potential problems and/or potential areas for improvement with respect to the current state of the art: (i) there are many fake or unauthorized replicas of the commercial products and materials in the marketplace, such replicas are referred to as counterfeits; (ii) the identification of counterfeit products protects reputations of brand names as well as the interests of loyal customers; and (iii) there is limited counterfeit data present for training detection models.

Some embodiments of the present invention are directed to detecting, within a product line or product industry, previously unknown patterns of replication or counterfeiting. Further, some embodiments of the present invention use technician feedback to identify brand names for newly discovered patterns of counterfeiting in a particular vector space. In that way, brand owners may monitor the number of counterfeit patterns for their brand in the marketplace.

Some embodiments of the present invention are directed to identifying whether a product or product component is counterfeit or authentic using similarity-based clustering. The difficulty of this objective it that counterfeits are designed to be identical to the products they replicate. Accordingly, a complete dataset pertaining to all counterfeits of a particular product is not available for training an identification model.

Some embodiments of the present invention are directed to performing a process to identify counterfeit products including: (i) training the twin Siamese network; (ii) generating model embeddings, also referred to as encoded feature representations; (iii) performing K-medoids generation using the model embeddings; (iv) getting thresholds for each cluster; (v) inferring a status of the given product; and (vi) new cluster generation for out-of-distribution data.

Some embodiments of the present invention are directed to a computer-implemented method for detecting a counterfeit object; the method comprising: (i) passing an image of an object into a trained Siamese network to generate an image embedding, or a coded feature representation; (ii) loading the embedding in the embedding space, or feature vector space, where there are at least two existing clusters with their medoids and corresponding thresholds, the at least two existing clusters including an authentic class and a counterfeit class; and (iii) assigning the embedding to one of at least two existing clusters based on the medoids and the corresponding thresholds, wherein if a distance between the embedding and each medoid is greater than any thresholds, a new cluster is generated. The at least two existing clusters were given by a K-Medoids model. The K-medoids model was selected from a plurality of K-Medoids models based on integrity of cluster (IOC). The IOC is calculated based on count of each ground truth label in each cluster, total data point in each cluster and total number of clusters. The corresponding thresholds were calculated as a radius of each cluster.

Some embodiments of the present invention are directed to loading the model embedding in the embedding space where there are at least two existing clusters with their medoids and corresponding thresholds, the at least two existing clusters including an authentic class and a counterfeit class are given by a K-Medoids model selected from a plurality of K-Medoids models based on integrity of cluster (IOC), and the IOC is calculated based on a count of each ground truth label in each cluster, a total data points in each cluster, and a total number of clusters; and

Some embodiments of the present invention are directed to assigning the embedding to one of at least two existing clusters based on the medoids and the corresponding thresholds calculated as a radius of each cluster, wherein if a distance between the embedding and each medoid is greater than any thresholds, a new cluster is generated.

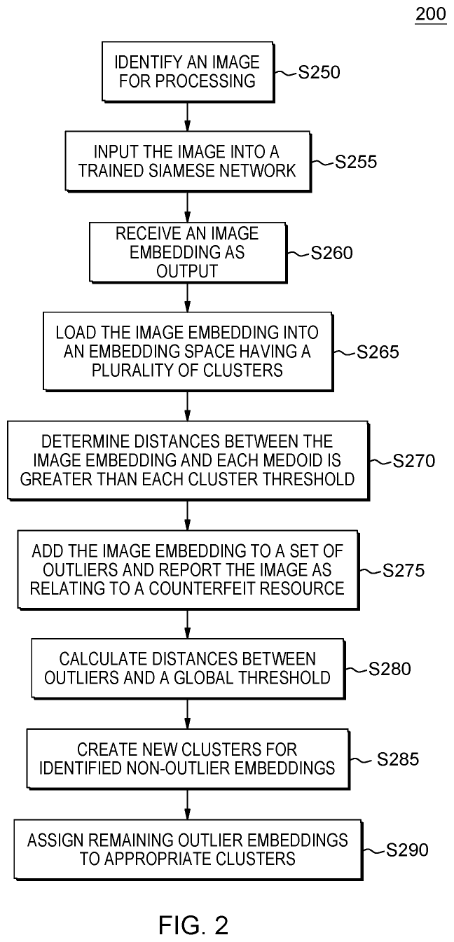

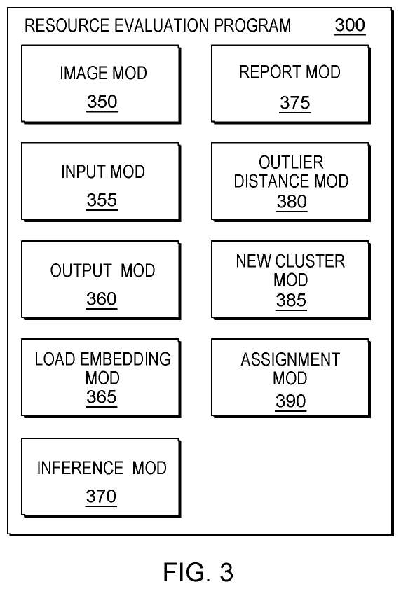

FIG. 2 shows flowchart 200 depicting a first method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S250, where image module (“mod”) 350 identifies an image for processing. In this example, images are identified for processing by receipt from user input. Alternatively, the image is identified when it is stored into an examination folder. Images are identified that represent resources, or physical objects, that are being evaluated for authenticity or for being made by an authentic supplier. As discussed herein, some embodiments of the present invention determine authenticity of resources by examination of high-definition images or microscopic images of portions of the physical objects.

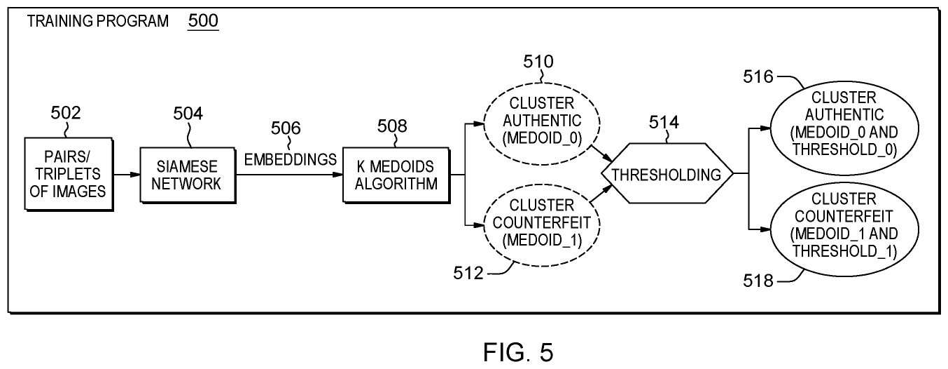

Processing proceeds to step S255, where input mod 355 inputs the identified image into a trained siamese network. In this example, the siamese network is training according to processes described herein, such as the process described in FIG. 5, performed by training program 500. The trained network creates an image embedding of the identified image.

Processing proceeds to step S260, where output mod 360 receives an image embedding of the identified image as output from the siamese network. The image embedding includes embedding space information for loading the image embedding into a given embedding space for evaluation.

Processing proceeds to step S265, where load embedding mod 365 loads the image embedding into an embedding space having a plurality of clusters. In this example, the embedding space uses clusters generated by a K-medoids model selected from a plurality of K-medoids models where an integrity of cluster method operates to identify the selected model. Each cluster in the embedding space has a dynamically calculated cluster threshold for identifying similar embeddings when loaded into the embedding space. Alternatively, the embedding space includes relevant clusters having designated cluster thresholds and specified medoids.

Processing proceeds to step S270, where inference mod 370 determines distances between the image embedding loaded in step S265 and each medoid of the plurality of clusters is greater than each calculated cluster threshold of the plurality of clusters. The image embedding generated by the trained siamese network includes embedding space information for measuring distances from the image embedding to existing clusters of the embedding space. Each cluster in the embedding space has a specified medoid and cluster threshold value. According to some embodiments of the present invention, the image embedding will have characteristics based on the embedding space information that locates the image embedding within a cluster. That is, within the range of distance from the medoid to the threshold limit. In the steps that follow, the image embedding does not fall within any medoid and corresponding cluster threshold such that it is deemed an “outlier.”

Processing proceeds to step S275, where report mod 375 adds the image embedding to a set of outliers and reports the corresponding image as relating to a counterfeit resource. In this example, the identified image relates to a resource for which a determination is to be made regarding the authenticity of the resource. When a determination is made that none of the distances from cluster medoids are within corresponding cluster thresholds, an inference of a counterfeit resource is made. In this example, when a counterfeit resource is inferred, the status of the resource is reported to the requesting user. In addition to any reporting requirement, in some embodiments of the present invention, the outlier image embedding is stored with other outlier embedding in a set of outliers. In this example, the stored outliers are collected until a threshold number of outlier embeddings are stored. Upon meeting the threshold number, the process moves forward to step S280. Alternatively, the advancing to step S280 is based on a pre-defined time period from the last operation of step S280. Alternatively, the advancing to step S280 is based upon a user-based action causing the step S280 to be performed.

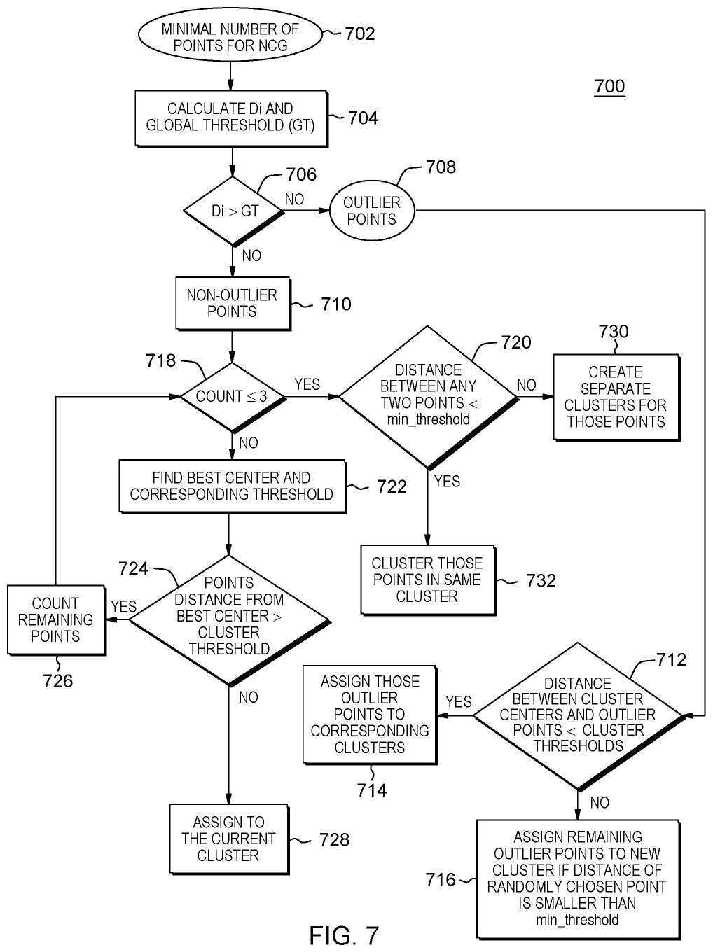

Processing proceeds to step S280, where outlier distance mod 380 calculates distances between outlier embeddings and a global threshold. Step S280 and the steps that follow operate to generate new clusters for “outlier” embeddings such that they belong to a cluster in the embedding space. According to some embodiments of the present invention, new clusters are formed by process 700 of FIG. 7. In this example, the distances between each outlier point and the set of outliers is used to generate a global threshold value.

Processing proceeds to step S285, where new cluster mod 385 creates new clusters for non-outlier embeddings. In this example, the average distances between each outlier point and the set of outliers is used to identify “non-outliers” from the set of outliers. Any outlier embeddings with an average distance from other embeddings less than the global threshold are stored in a single cluster as non-outliers.

Processing ends at step S290, where assignment mod 390 assigns the remaining outlier embeddings to appropriate clusters. In this example, each remaining outlier embedding is reevaluated by processing according to step S270 to identify any current clusters including new clusters where the outlier embeddings may be assigned. Those remaining outlier embedding that are not assigned to any of the current clusters may be assigned to a new cluster if certain criteria are met, such as described in step 716 of process 700 (FIG. 7).

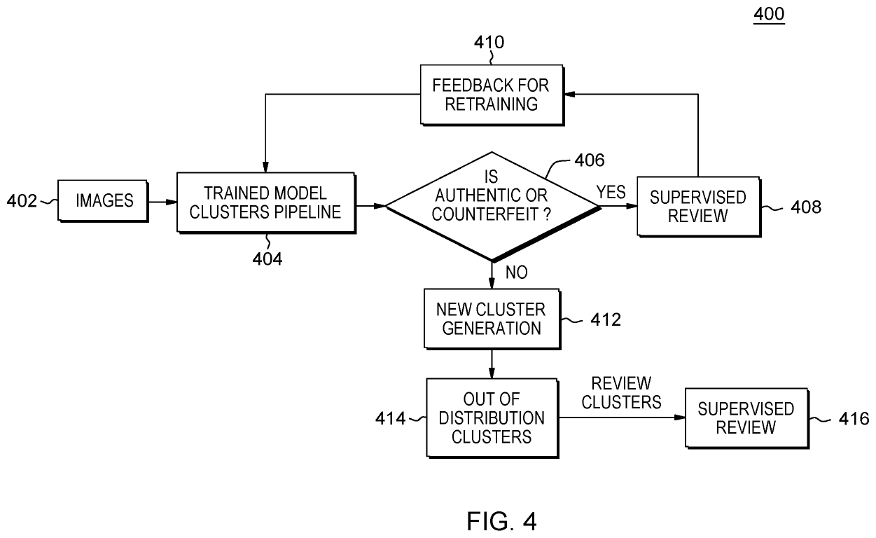

Further embodiments of the present invention are discussed in the paragraphs that follow and later with reference to FIGS. 4-7.

FIG. 4 shows flowchart 400 depicting a second method according to an embodiment of the present invention. This method will now be discussed, over the course of the following paragraphs and may be implemented on computing environment 100 (FIG. 1) by a program such as resource evaluation program 300.

Processing begins at step 402, where image sets are prepared for evaluation by a trained model for clustering images by similarity to existing images. The image sets may be in the form of image pairs or image triplets. The image pairs may be grouped as authentic/authentic, unauthorized/unauthorized, and/or authentic/unauthorized. For the triplets, the information may be in the form of “anchor, positive, and negative images.”

Processing proceeds to step 404, where the trained model evaluates the image sets in view of a clusters pipeline establishing clusters of resources of various origination including authorized origins. As discussed in more detail herein, the evaluation process may include image embedding of the image sets and evaluation of the embeddings with respect to clusters having pre-defined similarity thresholds for associating a new image with a particular cluster. The thresholds may be based on a Euclidian distance from a cluster centroid, or medoid for siamese network models.

Processing proceeds to decision step 406, where it is determined whether a target image represents a resource of authorized origin. For resources of authentic origin, processing follows the “YES” branch to step 408, where an expert review approves the determination and provides feedback (step 410) to the trained model for ongoing training refinement, reinforcement learning. For resources of unauthorized origin, processing follows the “NO” branch to step 412, where new clusters are generated to include the image of a resource of unauthorized origin.

If the target image represents an out-of-distribution resource, processing proceeds to step 414, where out-of-distribution resources are evaluated for inclusion into an existing cluster or for being deemed an outlier where a new cluster is established based on a randomly selected centroid.

Processing ends at step 416, where an expert evaluator reviews any new clusters created at steps 412 or 414 prior to recording the clusters to the clusters pipeline, or knowledge base.

Some embodiments of the present invention are directed to training a twin siamese network. A siamese network is a twin identical neural network that shares weight. The siamese network is defined with a pre-trained VGG (visual geometry group) or inception model. The data for establishing the selected model is divided into three parts: training data, test data, and validation data. Further some embodiments of the present invention retain an unseen or holdout dataset to test the model. Input to the model can be either a pair of images (authentic-authentic images and other pair of authentic-counterfeit images) or triplets (anchor, positive, and negative images).

FIG. 5 shows training program 500 and associated steps depicting a third method having a focus on establishing the training cluster pipeline according to an embodiment of the present invention. This method will now be discussed, over the course of the following paragraphs.

Processing begins at step 502, where image sets are prepared for training twin siamese network models for clustering images. The siamese network is defined with pre-trained VGG models. The image sets may be in the form of image pairs or image triplets. The image pairs may be grouped as authentic/authentic, unauthorized/unauthorized, and/or authentic/unauthorized. For the triplets, the information may be in the form of “anchor, positive, and negative images.” The image sets make up the training data, which may be divided up into three datasets, train, test, and validate.

Processing proceeds to step 504, where the twin siamese network receives the pairs or triplets of images as training datasets. Input to the model can be either a pair of images (authentic-authentic images and other pair of authentic-counterfeit images) or triplets (anchor, positive, and negative images).

Processing proceeds to step 506, where image embeddings are generated by the siamese network based on saved model weights, which are uniform across the twin models. Generated embeddings are stored for clustering decisions.

Some embodiments of the present invention are directed to generating model embeddings. A model embedding, also referred to herein as an image embedding, is a relatively low-dimensional space into which high-dimensional vectors can be translated. Model embeddings make it easier to perform machine learning on large inputs such as sparse vectors representing words. The process of generating model embeddings includes loading the saved siamese model weights. Passing the training set of images through a selected model and storing the embeddings generated by the models. The generated embeddings are 128 bytes each. The model embeddings are generated for the divided data, or data splits, discussed above as representing three parts, training data, test data, and validation data.

Processing proceeds to decision step 508, where a determination is made regarding authenticity of a given resource. Each image embedding represents a resource for which a determination is to be made as to the origination of the resource, whether authentic or counterfeit (unauthorized origination).

Some embodiments of the present invention are directed to using model embeddings for K-medoids model generation. The process may include training the K-Medoids model using python-based library to find two clusters where each represents either authentic or counterfeit in the embedding space from the generated model embeddings. The best K-medoids model is selected automatically according to the best parameters for a given dataset. A list of outputs from the best model is formed using all the parameters of the K-medoids algorithm in a sequential manner.

Processing proceeds to steps 510 and 512, where image embeddings are assigned to an authentic resource cluster, 510, or to an unauthorized resource cluster, 512, depending on the decision made at step 508. In this example, each K-medoids model outputs two clusters (Authentic, Counterfeit) responsive to K=2 being specified.

When selecting a best K-medoids model, the following steps may be performed: (i) for each model, calculate the integrity of a cluster (IOC) which is defined as:

$$\frac{1}{k} {\sum }_{i} max ( {C}_{i} ) / {N}_{i}$$

where:
Cᵢ=Count of each ground truth label in the ith cluster;
Nᵢ=Total data points in the ith cluster; and
k=Total number of clusters.
   In that way, the model with the best IOC value is selected as the best model for the given data. Further, the clusters from the selected best model are used as the best representative of the underlying segregated ground truth labels for the dataset.

Processing proceeds to step 514, where a threshold similarity is assigned to each cluster generated according to authenticity decisions of step 508. In this example, there are two clusters, authentic and counterfeit. In practice, many more clusters of counterfeit resources may be included in the embedding space as well as additional authentic clusters where authentic resources have different characteristics. Some embodiments of the present invention are directed to calculating thresholds for each cluster. Medoids are the representation of the cluster centers. The threshold is defined as the radius of each cluster to facilitate determining whether an image belongs to the cluster.

To calculate the threshold, reference is made to the lists of stored training and validation embeddings. Each list contains authentic and counterfeit images as follows:

TrainEmb=[TrainAuth,TrainCounter]ValEmb=[ValAuth,ValCounter]

Combining both datasets, based on the labels, into authentic and counterfeit lists as follows:

A_list=TrainAuth∪ValAuthC_list=TrainCounter∪ValCounter

Finally, for each of the lists, authentic (A-list) and counterfeit (C-list), the maximum distance of the image embeddings of the list with the corresponding cluster's medoids. It should be noted that for each cluster, its medoid is stored with the corresponding threshold. The threshold is defined as follows:

Threshᵤ=max(Vᵤ),

with Vu is defined as:
Vu=[Dist (Mᵤ, Embᵤ_{ᵢ})],
where:
i is a range from one to the number of embeddings;
u is a data label of “Authentic” or “Counterfeit”;
Mᵤ is the medoid of the u cluster; and
Embᵤ is either A_list or C_list, depending on the value of u.

Processing ends at steps 516 and 518, where clusters defined in steps 510 and 512 are updated with corresponding threshold similarity levels for each cluster.

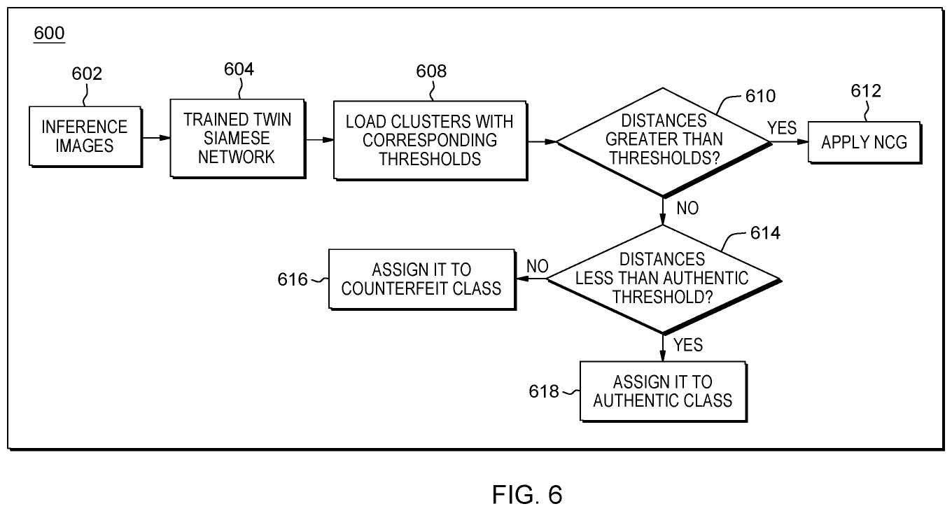

FIG. 6 shows flowchart 600 depicting a fourth method having a focus on establishing an inference pipeline according to an embodiment of the present invention. This method will now be discussed, over the course of the following paragraphs and may be implemented on computing environment 100 (FIG. 1) by a program such as resource evaluation program 300.

Processing begins at step 602, where inference images are prepared for submission to the trained twin siamese network. The inference image is a target image for which the trained system is to determine authenticity. Some embodiments of the present invention are directed to drawing an inference as to the status of a given product. The inference is made when checking if a given image represents an authentic or an unauthorized origination.

Processing proceeds to step 604, where a target image, or inference image, is input to the siamese network as defined above to generate the embedding for the target image.

Processing proceeds to step 608, where the embedding is loaded into the embedding space where there are two existing clusters having medoids and corresponding thresholds are recorded.

Processing proceeds to decision step 610, where a determination is made regarding the generated image embedding distance from the cluster medoids. The Euclidean distance between the medoids and the generated embedding is compared with the thresholds to assign the generated embedding to the clusters according to an assignment scheme based on the decision made. If the distance is greater than both the thresholds, processing follows the “YES” branch to step 612, where the embedding is stored until a specified minimal point limit is reached. The minimal point limit is the minimum number of embeddings on which new cluster generation should be based. If the distance is less than either threshold, processing follows the “NO” branch to decision step 614.

Following the “NO” branch to decision step 614, a determination is made as to the distance from the authentic cluster. If the distance from the authentic cluster medoid is less than the cluster threshold distance of the authentic cluster, processing follows the “YES” branch to step 618, where the inference image, or embedding, is assigned to the authentic classification. If the distance from the counterfeit cluster medoid is less than the cluster threshold distance of the counterfeit cluster, processing follows the “NO” branch to step 616, where the inference image, or embedding, is assigned to the corresponding counterfeit classification.

When the distance is less than both the thresholds, assign the target image, or embedding, to the lower distant cluster. Upon inference, the status of the given image will be one of authentic, counterfeit, or out of distribution. Those images assigned the status of out of distribution may be clustered according to a new cluster generation (NCG) process illustrated in FIG. 7.

Some embodiments of the present invention are directed to new cluster generation (NCG) for out of distribution cluster assignment. The NCG process may be defined as follows: (i) calculate Euclidean distance of each point with other remaining points and average distance for each point, Di as follows:

$${D}_{i} = \frac{\sum dist ( i , j )}{n - 1}$$

where:
i is the current image embedding,
j is the embeddings other than i,
n is the total number of embeddings, and
dist is the Euclidean distance between two points;
(ii) calculate the global threshold (GT):

$$G T = \frac{1}{n} \sum ( \frac{\sum dist ( i , j )}{n - 1} ) ;$$

and
(iii) assigned embeddings with Di greater than GT to be outliers; and (iv) choose the best center for the non-outlier points:

$$best center = min ( \frac{\sum dist ( i , j )}{n - 1} )$$

It should be noted that when the minimal points according to the minimal point limit are clustered, there may be a human intervention to review the formed clusters.

FIG. 7 shows flowchart 700 depicting a fifth method having a focus on generating new clusters according to an embodiment of the present invention. This method will now be discussed, over the course of the following paragraphs and may be implemented on computing environment 100 (FIG. 1) by a program such as resource evaluation program 300.

Processing begins at step 702, where a minimal number of points are determined for new cluster generation. The determination of a minimal number of data points will vary according to user and/or overall policy. In some embodiments of the present invention, a threshold amount of time must pass before checking the number of outlier points to be evaluated. When both the time threshold is met and the threshold number of data points are met, process may begin. Alternatively, periodic evaluation of the number of data points is performed until a threshold number of data points are collected.

Processing proceeds to step 704, where the system calculates the distance for each outlier data point, Di and the global threshold (GT). The GT is calculated as discussed earlier in this application. Alternative calculations may be performed to determine a suitable cluster threshold for a new cluster. Suitability may be based on the number of embeddings that fit within the cluster threshold.

Processing proceeds to decision step 706, where a comparison is made between the distance for each point and the global threshold. After grouping the points by whether or not they are greater than or less than the global threshold, processing follows to process batches of points. If the distances are greater than the global threshold, processing follows the “YES” branch to step 708, for outlier points. If the distances are less than the global threshold, processing follows the “NO” branch to step 710 for non-outlier points.

Following the “YES” branch to step 708, outlier points are processed. Outlier points are evaluated to determine to which cluster to assign the image or when to assign to a new smaller cluster.

Processing proceeds to decision step 712, where the distance between cluster centers, medoids, and the outlier points is compared to the cluster threshold. Where the cluster thresholds are greater than the distance, processing follows the “YES” branch to step 714, where processing ends with assigning the outlier point to the corresponding cluster with the greater distance. If the cluster thresholds are less than the distance, processing follows the “NO” branch to step 716, where processing ends with assigning the outlier point to a new cluster if distance of randomly chosen point is smaller than the minimum threshold of the cluster thresholds.

Following the “NO” branch from step 706, processing proceeds to step 710, where non-outlier points are processed.

Processing proceeds to decision step 718, where a count of non-outlier points determine which branch to take. When the non-outlier count is greater than or equal to three, processing follows the “YES” branch to decision step 720. When the non-outlier count is less than three, processing follows the “NO” branch to step 722.

Following the “NO” branch, processing proceeds to step 722, where the best center is identified along with the corresponding threshold for each non-outlier point.

Processing proceeds to decision step 724, where each points distance from the best center is compared to the corresponding cluster threshold. For each points distance that is less than the cluster threshold, processing follows the “NO” branch and ends at step 728, where the identified non-outlier points are assigned to the current cluster. For each points distance that is greater than the cluster threshold, processing follows the “YES” branch to step 726, where remaining non-outlier points are counted.

Following the “YES” branch to step 726, the remaining non-outlier points are counted.

Processing proceeds back to decision step 718, where it is determined whether the count of non-outlier points is less than or equal to three.

Following the “YES” branch, where the count is less than or equal to three, processing proceeds to decision step 720, where it is determined if the distance between any two non-outlier points is less than a minimum threshold value. If the distance between any two points is less than the minimum threshold value, processing follows the “NO” branch to step 730. If no distance is less than the minimum threshold value, processing follows the “YES” branch to step 732, where processing ends when the remaining non-outlier points are assigned to the same cluster.

Following the “NO” branch, processing ends at step 730, where separate clusters are created for the non-outlier points.

Some embodiments of the present invention may include one, or more, of the following features, characteristics and/or advantages: (i) improve detection of counterfeits using images of microscopic or high definition regions of interest of the target products; (ii) uncover/discover unseen new counterfeits as they come in the market; (iii) robust system for finding the similarity between products and for identifying a counterfeit with good accuracy; (iv) provides for forgery detection in art industry; (v) facilitates checking if products received for sale are authentic; (vi) identifies counterfeit and authentic products in fashion industry; (vii) identifies counterfeit and authentic food and beverages, such as wines, and juices; and (viii) identify counterfeit currency.

Some embodiments of the present invention are directed to a process that includes: (i) imputing pairs/triplets of images to a trained Siamese network to classify the images based on the K-medoid clustering of embeddings, applying an integrity method for selecting the best model for the given data, and generating new clusters for images leading to out-of-distribution results.

Some embodiments of the present invention are directed to a semi-supervised similarity-based machine learning approach including: (i) an end-to-end system of training the similarity model followed by applying K-medoids to form clusters; (ii) an integrity of cluster (IOC) method used in K-medoids clustering to choose the best model; (iii) defining a threshold for each of the clusters based on both training and validation data; and (iv) new cluster generation for out of distribution data.

Some embodiments of the present invention are directed to a process including: embedding of images, low similarity score for authentic-counterfeit images, high similarity score for authentic-authentic images, clustering in the embedding space using the integrity of cluster method, specifying a dynamically calculated threshold for each cluster, and using Euclidean distance to classify a new sample at the time of inference of image status (authentic, counterfeit, or out-of-distribution.

Some embodiments of the present invention are directed to generating model embeddings from a siamese network and applying K-Medoids clustering in the embedding space.

Some embodiments of the present invention are directed to an algorithm to generate two cluster centers (or more based on problem set) with the help of training data embeddings with inferences made by applying clustering in the embedding space.

Some embodiments of the present invention are directed to generating embeddings based on the pairs/triplets of images and then applying an integrity process to automatically generate useful clusters.

Some embodiments of the present invention are directed to use siamese networks only to generate model embeddings.

Some embodiments of the present invention are directed to developing a robust deep neural siamese network and clustering methods where few samples of original and counterfeit product images are available.

Some embodiments of the present invention are directed to a technique for selecting the best model by assessing the integrity of all the clusters for each model and using all the possible parameters of the clustering technique. When there are multiple models having the same highest overall integrity of cluster, the system may select the model with the highest integrity of authentic cluster so as to make the authentic cluster more robust.

Some embodiments of the present invention are directed to using high-level features in the vector space to combine patterns with comparable characteristics without limiting the number of possible groupings. With the assistance of the technician, the patterns found in the vector space are always being improved.

Some embodiments of the present invention are directed to establishing cluster thresholds by producing concise, individual boundary-based clusters for feature representations or patterns associated with goods that are genuine and that are counterfeit. Further, some embodiments of the present invention are directed to resolving in-class tolerance parameters distinguishing authentic and counterfeit goods.

Some embodiments of the present invention are directed to identifying outliers within newly recognized counterfeit patterns in the vector space by defining a minimum range to form new pattern clusters for pattern outliers with reference to a universal boundary and cluster borders.

Some embodiments of the present invention are directed to a computer program product for detecting a counterfeit good, comprising: capturing a photo of a good/commodity that stimulates the computer program after receiving the input; identifying the authenticity of a product, comprising: receiving a product image at a program end; identifying encoded feature representation; and loading the trained existing model with corresponding thresholds; generating, based on the model representations, an output to inform user about the authenticity of the product; and receiving human feedback on the identification done by the computer program, to improve the weights and parameters of trained clusters. The identifying encoded feature representation, comprises, generating encoded representation from, shared weights and parameters of encoder, the trained model in the network, and producing the distance of embeddings in the vector space to assign the cluster to the feature representation. The assigning the cluster to the feature representation includes comparing the feature representation distance with the thresholds of existing clusters in the feature vector space and assigning feature representation to the existing cluster based on the distance from the center or forming a new cluster. The forming a new cluster is a generation of clusters for unidentified counterfeits of a product. The receiving human feedback on the identification done by the computer program, comprises: receiving input from user to confirm the output of the computer program; sending verified inputs to the system for adjusting, weights and parameters, of the model; and improving output accuracy of the system with continuous feedback. The loading the trained existing model with corresponding thresholds is a stored medoids with threshold, at time of training.

Some embodiments of the present invention are directed to a method of implementing detection of a counterfeit product by similarity learning on high definition or microscopic images, the method comprising: receiving a set of authentic product images simulated by a mobile enabled camera; receiving a set of counterfeit product images simulated by a mobile enabled camera; generating image pairs of first set of authentic images and second set of counterfeit images and image pairs within first set of authentic images, wherein first pair is authentic-authentic pair, and second pair is authentic-counterfeit pair; for each image pair in the plurality of image pairs: training a first network of shared parameters, an encoder, to generate a feature representation of the first image of a pair, wherein the encoder comprising a backbone of a neural network; training a second network of shared parameters with an encoder to generate a feature representation of the second image of a pair; and loading representations in the feature vector space and adjusting the set of one or more weights to increase a degree of thresholding to form clusters. The backbone of a neural network is a pre-trained neural network. The set of shared parameters is a part of encoders with same weights and parameters. The loading representations in the feature vector space includes: training a clustering model with each encoded representation in the vector space; choosing a best model from the list of parameters for each clustering model; and resulting best representative of the underlying segregated ground truth labels for the encoded representation. The choosing a best model from list of parameters for each clustering model, includes: applying goodness of a clusters generated within each model; obtaining model where all the clusters have the best integrity of cluster for each encoded embedding; and checking possibility of multiple models with highest overall integrity of cluster being same, pick the model with highest integrity of authentic cluster. The highest integrity of authentic cluster is performed to make authentic cluster more robust that in-turn improves counterfeit detection. The increase in degree of thresholding to form clusters, comprises: receiving medoids of the clusters generated as the representations of the centers of the cluster; and considering, encoded feature representation, of both seen set of pairs of images and validation set of pair of images to obtain the threshold of each cluster of the selected model.

Some embodiments of the present invention are directed to a process for identifying a new counterfeit product as it arrives in the marketplace, the process including: receiving a product image at a program end; identifying encoded feature representation; loading the trained existing model with corresponding thresholds; checking the existing clusters dimensionality for the encoded feature representation; generating new clusters for the representations that are previously unidentified; and receiving human feedback on the cluster identification for process improvement. The generating new clusters for the representations, may include: finding the outlier representation within the new feature representations in the vector space, determining the non-outlier points from the set of new feature representations in the vector space, and initializing clusters for both outlier and non-outlier points to belong together, with the similar representations, in the feature space. The finding the outlier representation may include: generating a global threshold for the clusters of the system in the vector space; choosing a best center having data points closer to each other for the representations present in the space; setting the boundary for each cluster by generating a minimum threshold; and assigning new counterfeit product outlier encoded representations to new clusters. The determining non-outlier points within the new counterfeit products encoded representation, may include: calculating an average distance for product encoded representation with the other representations present in the vector space; choosing a best center accompanied by finding the radius of a cluster; and assigning new counterfeit product non-outlier encoded representations to new clusters. The choosing a best center is based on finding a data point in the vector space where the density of encoded representations is high.

Some embodiments of the present invention are directed to a method that requires just a few samples of original and counterfeit products for training, to identify counterfeit products in the market, comprises: small number of samples of authentic and counterfeit product to train the system, and collecting images of all the fake products in the market is impossible. The small number of samples of authentic and counterfeit product to train the system, comprises: generating pairs of images, encoded feature representations, before sending to encoders with shared weights and parameters; randomly choosing authentic product images to pair with other images in the set, to form a set of pairs of authentic-authentic products; and randomly choosing authentic product images to pair with fake product images, to form a set of authentic-fake products.

Some embodiments of the present invention are directed to a system that can withstand subtle variations between authentic and counterfeit products, comprising: identifying close distribution of authentic representation in the vector space; and assuring tight integrity for all the groups of various representations in the vector space. The close distribution of authentic representation is done to make authentic products encoded representation more robust and detection of counterfeits better.

According to some embodiments of the present invention, a pair of images of authentic and counterfeit object are passed to a siamese network. No pre-processing is applied to the input of the siamese network. Images of the object are used to detect a counterfeit product with the help of deep learning and machine learning methods. Images of authentic product is input through the similarity-based learning model. These images are passed through the twin Siamese network to generate the model embeddings. The trained siamese network extracts the feature encoding from the images.

Some embodiments of the present invention are directed to generating feature encoding using a twin siamese network. Trained weights are used to generate embeddings when a new product image is captured to facilitate capture of visual information from the image to determine if the new product is an authentic or a counterfeit product.

Some embodiments of the present invention are directed to using RGB colored images of actual product from a camera as inputs to the network. Further, some embodiments perform preprocessing or segmentation on the images. Additionally, the trained siamese network may extract the model embeddings for downstream processing in the clustering algorithm.

Some embodiments of the present invention are directed to using K-medoid clustering to generate two or more clusters for authentic and counterfeit object image embeddings respectively. Some embodiments further load feature encodings in the embedding space where two clusters with the corresponding medoids are present. At the training stage, the clusters are formed with the provided images and corresponding medoids are stored. A new image encoding may be compared with the cluster medoid and the threshold to determine if the corresponding product is either authentic or counterfeit.

Some embodiments of the present invention are directed to detecting a counterfeit product by using a siamese network and K-medoid clustering. A new cluster is generated when different counterfeits or authentic objects are detected.

Some embodiments of the present invention are directed to identifying a counterfeit or authentic product based on a captured image. The disclosed framework encompasses receiving a product image at a program end, identifying encoded feature representation, loading the trained existing model with corresponding thresholds and generating, based on the model representations, an output to inform user about the authenticity of the product.

Some embodiments of the present invention are directed to a computer-implemented method including: loading a first embedding of a first image into an embedding space where there is a plurality of existing clusters of other image embeddings, the plurality of existing clusters having defined respective medoids and corresponding cluster thresholds, the plurality of existing clusters including an authentic class cluster and a counterfeit class cluster; and determining medoid distances between the first embedding and the respective medoids of the plurality of existing clusters; comparing a first medoid distance to a corresponding cluster threshold of a first cluster; responsive to no medoid distance to any cluster being less than respectively corresponding cluster thresholds, assigning the first embedding to a set of outlier embeddings not matching any cluster; and reporting the first image as representing a counterfeit resource.

One aspect of the computer-implemented method disclosed herein may include inputting the first image into the trained siamese network to generate the first embedding.

Another aspect of the computer-implemented method disclosed herein may include: training a siamese network of shared parameters with pairs of images representing authentic and counterfeit resources to create the trained siamese network, the siamese network generating image embeddings of each image; generating, by the siamese network and under expert supervision, K-medoids models for creating a cluster of authentic image embeddings and a cluster of counterfeit image embeddings; calculating integrity of cluster (IOC) for clusters created by the K-medoids models, the IOC being based on a count of ground truth labels in each cluster, a total number of image embeddings in each cluster, and a total number of clusters in the embedding space; and selecting the selected K-medoids model from a set of K-medoids models based on a comparison of the calculated IOC of clusters created by each K-medoids model, the selected K-medoids model having a preferred IOC. The at least two existing clusters were created by a selected K-medoids model.

Yet another aspect of the computer-implemented method disclosed herein may include: determining a count of outlier embeddings in the set of outlier embeddings; responsive to the count meeting at least a threshold number of embeddings, and generating a new cluster in the embedding space by: generating a global threshold for plurality of existing clusters in the embedding space; selecting a best center among the set of outlier embeddings in the embedding space, wherein selected close outlier embeddings make up a set of non-outlier embeddings having the best center as a new medoid of the new cluster; and generating a cluster threshold for the new cluster based on a minimum distance from the new medoid to enclose the set of non-outlier embeddings.

Still yet another aspect of the computer-implemented method disclosed herein may be that the corresponding cluster thresholds are calculated for each cluster as a radius.

Some embodiments of the present invention are directed toward a computer program product comprising: training a siamese network of shared parameters with pairs of images representing authentic and counterfeit resources to create the trained siamese network, the siamese network generating image embeddings of each image; generating, by the siamese network and under expert supervision, K-medoids models for creating a cluster of authentic image embeddings and a cluster of counterfeit image embeddings; calculating integrity of cluster (IOC) for clusters created by the K-medoids models, the IOC being based on a count of ground truth labels in each cluster, a total number of image embeddings in each cluster, and a total number of clusters in the embedding space; and selecting the selected K-medoids model from a set of K-medoids models based on a comparison of the calculated IOC of clusters created by each K-medoids model, the selected K-medoids model having a preferred IOC. The at least two existing clusters were created by a selected K-medoids model.

Yet another aspect of the computer program product disclosed herein may include: determining a count of outlier embeddings in the set of outlier embeddings; responsive to the count meeting at least a threshold number of embeddings, and generating a new cluster in the embedding space by: generating a global threshold for plurality of existing clusters in the embedding space; selecting a best center among the set of outlier embeddings in the embedding space, wherein selected close outlier embeddings make up a set of non-outlier embeddings having the best center as a new medoid of the new cluster; and generating a cluster threshold for the new cluster based on a minimum distance from the new medoid to enclose the set of non-outlier embeddings.

Still yet another aspect of the computer program product disclosed herein may be that the corresponding cluster thresholds are calculated for each cluster as a radius.

Some embodiments of the present invention are directed toward a computer system including: a processor set; and a computer readable storage medium. The processor set is structured, located, connected, and/or programmed to run program instructions stored on the computer readable storage medium. The program instructions, when executed by the processor set, cause the processor set to perform a method including: training a siamese network of shared parameters with pairs of images representing authentic and counterfeit resources to create the trained siamese network, the siamese network generating image embeddings of each image; generating, by the siamese network and under expert supervision, K-medoids models for creating a cluster of authentic image embeddings and a cluster of counterfeit image embeddings; calculating integrity of cluster (IOC) for clusters created by the K-medoids models, the IOC being based on a count of ground truth labels in each cluster, a total number of image embeddings in each cluster, and a total number of clusters in the embedding space; and selecting the selected K-medoids model from a set of K-medoids models based on a comparison of the calculated IOC of clusters created by each K-medoids model, the selected K-medoids model having a preferred IOC. The at least two existing clusters were created by a selected K-medoids model.

Yet another aspect of the computer system disclosed herein may include: determining a count of outlier embeddings in the set of outlier embeddings; responsive to the count meeting at least a threshold number of embeddings, and generating a new cluster in the embedding space by: generating a global threshold for plurality of existing clusters in the embedding space; selecting a best center among the set of outlier embeddings in the embedding space, wherein selected close outlier embeddings make up a set of non-outlier embeddings having the best center as a new medoid of the new cluster; and generating a cluster threshold for the new cluster based on a minimum distance from the new medoid to enclose the set of non-outlier embeddings.

Still yet another aspect of the computer system disclosed herein may be that the corresponding cluster thresholds are calculated for each cluster as a radius.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as may be being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method comprising:
loading a first embedding of a first image into an embedding space where there is a plurality of existing clusters of other image embeddings, the plurality of existing clusters having defined respective medoids and corresponding cluster thresholds, the plurality of existing clusters including an authentic class cluster and a counterfeit class cluster;
determining medoid distances between the first embedding and the respective medoids of the plurality of existing clusters;
comparing a first medoid distance to a corresponding cluster threshold of a first cluster;
responsive to no medoid distance to any cluster being less than respectively corresponding cluster thresholds, assigning the first embedding to a set of outlier embeddings not matching any cluster; and
reporting the first image as representing a counterfeit resource.

2. The computer-implemented method of claim 1, further comprising:
inputting the first image into the trained siamese network to generate the first embedding.

3. The computer-implemented method of claim 1, further comprising:
training a siamese network of shared parameters with pairs of images representing authentic and counterfeit resources to create the trained siamese network, the siamese network generating image embeddings of each image; and
generating, by the siamese network and under expert supervision, K-medoids models for creating a cluster of authentic image embeddings and a cluster of counterfeit image embeddings;
wherein:
the at least two existing clusters were created by a selected K-medoids model.

4. The computer-implemented method of claim 3, further comprising:
calculating integrity of cluster (IOC) for clusters created by the K-medoids models, the IOC being based on a count of ground truth labels in each cluster, a total number of image embeddings in each cluster, and a total number of clusters in the embedding space; and
selecting the selected K-medoids model from a set of K-medoids models based on a comparison of the calculated IOC of clusters created by each K-medoids model, the selected K-medoids model having a preferred IOC.

5. The computer-implemented method of claim 1, further comprising:
determining a count of outlier embeddings in the set of outlier embeddings; and
responsive to the count meeting at least a threshold number of embeddings, generating a new cluster in the embedding space.

6. The computer-implemented method of claim 5, wherein generating the new cluster in the embedding space includes:
generating a global threshold for plurality of existing clusters in the embedding space;
selecting a best center among the set of outlier embeddings in the embedding space, wherein selected close outlier embeddings make up a set of non-outlier embeddings having the best center as a new medoid of the new cluster; and
generating a cluster threshold for the new cluster based on a minimum distance from the new medoid to enclose the set of non-outlier embeddings.

7. The computer-implemented method of claim 1, wherein the corresponding cluster thresholds are calculated for each cluster as a radius.

8. A computer program product comprising a computer-readable storage medium having a set of instructions stored therein which, when executed by a processor, causes the processor to perform a method comprising:
loading a first embedding of a first image into an embedding space where there is a plurality of existing clusters of other image embeddings, the plurality of existing clusters having defined respective medoids and corresponding cluster thresholds, the plurality of existing clusters including an authentic class cluster and a counterfeit class cluster;
determining medoid distances between the first embedding and the respective medoids of the plurality of existing clusters;
comparing a first medoid distance to a corresponding cluster threshold of a first cluster;
responsive to no medoid distance to any cluster being less than respectively corresponding cluster thresholds, assigning the first embedding to a set of outlier embeddings not matching any cluster; and
reporting the first image as representing a counterfeit resource.

9. The computer program product of claim 8, further causing the processor to perform a method comprising:
inputting the first image into the trained siamese network to generate the first embedding.

10. The computer program product of claim 8, further causing the processor to perform a method comprising:
training a siamese network of shared parameters with pairs of images representing authentic and counterfeit resources to create the trained siamese network, the siamese network generating image embeddings of each image; and
generating, by the siamese network and under expert supervision, K-medoids models for creating a cluster of authentic image embeddings and a cluster of counterfeit image embeddings;
wherein:
the at least two existing clusters were created by a selected K-medoids model.

11. The computer program product of claim 10, further causing the processor to perform a method comprising:
calculating integrity of cluster (IOC) for clusters created by the K-medoids models, the IOC being based on a count of ground truth labels in each cluster, a total number of image embeddings in each cluster, and a total number of clusters in the embedding space; and
selecting the selected K-medoids model from a set of K-medoids models based on a comparison of the calculated IOC of clusters created by each K-medoids model, the selected K-medoids model having a preferred IOC.

12. The computer program product of claim 8, further causing the processor to perform a method comprising:
determining a count of outlier embeddings in the set of outlier embeddings; and
responsive to the count meeting at least a threshold number of embeddings, generating a new cluster in the embedding space.

13. The computer program product of claim 12, wherein generating the new cluster in the embedding space includes:
generating a global threshold for plurality of existing clusters in the embedding space;
selecting a best center among the set of outlier embeddings in the embedding space, wherein selected close outlier embeddings make up a set of non-outlier embeddings having the best center as a new medoid of the new cluster; and
generating a cluster threshold for the new cluster based on a minimum distance from the new medoid to enclose the set of non-outlier embeddings.

14. The computer program product of claim 8, wherein the corresponding cluster thresholds are calculated for each cluster as a radius.

15. A computer system comprising:
a processor(s) set; and
a computer readable storage medium having program instructions stored therein;
wherein:
the processor set executes the program instructions that cause the processor set to perform a method comprising:
loading a first embedding of a first image into an embedding space where there is a plurality of existing clusters of other image embeddings, the plurality of existing clusters having defined respective medoids and corresponding cluster thresholds, the plurality of existing clusters including an authentic class cluster and a counterfeit class cluster;
determining medoid distances between the first embedding and the respective medoids of the plurality of existing clusters;
comparing a first medoid distance to a corresponding cluster threshold of a first cluster;
responsive to no medoid distance to any cluster being less than respectively corresponding cluster thresholds, assigning the first embedding to a set of outlier embeddings not matching any cluster; and
reporting the first image as representing a counterfeit resource.

16. The computer system of claim 15, further causing processor set to perform a method comprising:
inputting the first image into the trained siamese network to generate the first embedding.

17. The computer system of claim 15, further causing the processor to perform a method comprising:
training a siamese network of shared parameters with pairs of images representing authentic and counterfeit resources to create the trained siamese network, the siamese network generating image embeddings of each image; and
generating, by the siamese network and under expert supervision, K-medoids models for creating a cluster of authentic image embeddings and a cluster of counterfeit image embeddings;
wherein:
the at least two existing clusters were created by a selected K-medoids model.

18. The computer system of claim 17, further causing the processor to perform a method comprising:
calculating integrity of cluster (IOC) for clusters created by the K-medoids models, the IOC being based on a count of ground truth labels in each cluster, a total number of image embeddings in each cluster, and a total number of clusters in the embedding space; and
selecting the selected K-medoids model from a set of K-medoids models based on a comparison of the calculated IOC of clusters created by each K-medoids model, the selected K-medoids model having a preferred IOC.

19. The computer system of claim 15, further causing the processor to perform a method comprising:
determining a count of outlier embeddings in the set of outlier embeddings; and
responsive to the count meeting at least a threshold number of embeddings, generating a new cluster in the embedding space.

20. The computer system of claim 19, wherein generating the new cluster in the embedding space includes:
generating a global threshold for plurality of existing clusters in the embedding space;
selecting a best center among the set of outlier embeddings in the embedding space, wherein selected close outlier embeddings make up a set of non-outlier embeddings having the best center as a new medoid of the new cluster; and
generating a cluster threshold for the new cluster based on a minimum distance from the new medoid to enclose the set of non-outlier embeddings.
